(19) United States
(12) Patent Application Publication
(10) Pub. No.: US 2023/0394567 A1
(43) Pub. Date: Dec. 7, 2023

(54) Wager Ticket Converter to NFT Memorabilia

(71) Applicant: Stephen Groce, San Diego, CA (US)

(72) Inventor: Stephen Groce, San Diego, CA (US)

(21) Appl. No.: 18/306,014

(22) Filed: Apr. 24, 2023

Related U.S. Application Data
(60) Provisional application No. 63/334,062, filed on Apr. 22, 2022.
(60) Provisional application No. 63/334,459, filed on Apr. 25, 2022.

(51) Int. Cl. G06Q 30/08; G06Q 20/36; G06Q 20/38

(52) U.S. Cl. CPC G06Q 30/08; G06Q 20/389; G06Q 20/3672

(57) ABSTRACT

Bet wager tickets (bet slips) for teams within a particular league are purchased on opening day from a sportsbook. Each bet slip is photographed and minted as a non-fungible token on a distributed ledger such as the Ethereum blockchain. The non-fungible tokens are placed on sale at auction for the duration of the season or for a predetermined period of time. At the conclusion of the season, each non-fungible token is sold to the highest bidder, who also receives either the physical wager ticket or its winning value.

### RELATED APPLICATIONS

This application claims priority to U.S. Provisional Patent Application Ser. No. 63/334,459 for a “Wager Ticket Converter to NFT Memorabilia,” filed Apr. 25, 2022, and currently co-pending, and also claims priority to U.S. Provisional Patent Application Ser. No. 63/334,062 for a “Wager Ticket Converter to NFT Memorabilia,” filed Apr. 22, 2022, and currently co-pending. The aforementioned related applications are incorporated herein in their entirety by reference.

### FIELD OF THE INVENTION

The present invention pertains generally to non-fungible tokens created on a distributed blockchain ledger, and is particularly, though not exclusively, useful as a process for converting wager tickets to non-fungible token sports memorabilia.

### BACKGROUND OF THE INVENTION

Professional sports, from horse racing to football, have long attracted individuals seeking to profit by betting on the winners of upcoming competitions. Sports betting is thus a game played in relation to another game, and for many is an important part of the entertainment and enjoyment provided by professional sports.

In sports betting, a “wager ticket” or “bet slip” is a receipt confirming a placed bet, and usually lists the selections for predicted winners, odds, and other relevant information. Such bets are made at a place referred to as a “sportsbook.”

Other fans of sports collect memorabilia, such as keepsakes related to athletes, teams, or particularly memorable games, as part of their appreciation and enjoyment of sports. Such keepsakes include trading cards, posters, clothing, autographed items, and coins, among other collectible items. The memorabilia may be acquired for keeping, selling, or trading, or a collector may engage in a combination of those activities.

In many cases, a single sports fan is interested in both betting and collecting. Nonetheless, these have traditionally been two separate industries, with little understanding in the respective professions of how betting and collecting might be combined. Thus, a sports fan makes bets and collects memorabilia as distinct endeavors, despite engagement in both hobbies.

In view of the above, it would be advantageous to provide a way to combine sports betting and collecting. It would be further advantageous to provide a wager ticket with intrinsic or keepsake value. It would be further advantageous to provide a combination of sports betting and memorabilia with a built-in mechanism for selling or trading the memorabilia.

### SUMMARY OF THE INVENTION

Disclosed is a system and process for converting wager tickets into non-fungible token (NFT) sports memorabilia art. In a preferred embodiment, bet wager tickets (bet slips) for teams within a particular league are purchased on opening day from a sportsbook. Each bet slip is photographed and minted on a blockchain ledger, such as the Ethereum blockchain.

In some embodiments the minted NFT is placed on sale at auction for the duration of the season. In other embodiments, it is held in a digital wallet and placed on sale at auction at or near the end of the season.

In some preferred embodiments, pre-NFT player position certificates (PNPPC) corresponding to the NFTs are created and sold for predetermined teams and held by the buyer until the end of the season. At the end of the season, if the corresponding NFT has not been sold, the PNPPC holder retains the PNPPC as sports memorabilia art. If the NFT has been sold, the PNPPC holder receives back the purchase price of the PNPPC and a portion, one percent (1%) in a preferred embodiment, of the price at which the NFT was sold at auction.

The purchaser of the NFT at auction receives the NFT via the customary transfer of digital goods on the blockchain, as well as the physical wager ticket or bet slip, or the winning value of wager ticket instead of the physical wager ticket.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a diagram of the resources involved in a preferred embodiment of a process for converting wager tickets to NFT memorabilia;

FIG. 2 is a flowchart of a preferred embodiment of a process for converting wager tickets to NFT memorabilia; and

FIG. 3 is a detailed diagram of process flow for a preferred embodiment of a process for converting wager tickets to NFT memorabilia.

### DETAILED DESCRIPTION

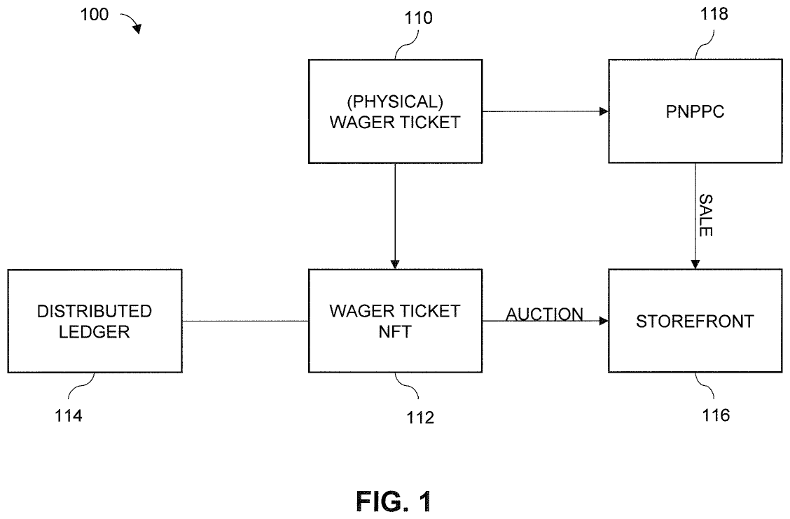

Referring initially to FIG. 1, a preferred embodiment of a system for converting wager tickets to NFT memorabilia is illustrated and generally designated 100. A physical wager ticket 110 is photographed and converted into a non-fungible token (NFT) wager ticket 112 on a distributed ledger 114 such as the Ethereum blockchain. By its nature, the distributed ledger 114 is located on many computing devices around the world and uses a consensus algorithm and cryptography to provide secure, decentralized transactions.

The NFT wager ticket 112 is offered for sale at auction on storefront 116. In preferred embodiments, storefront 116 is an internet-based storefront accessible from a website, mobile application, or both. Such embodiments of storefront 116 therefore run on one or more servers having data storage, processors, and network hardware, although in some embodiments this takes place through layers of abstraction in the form of virtual servers or “serverless” design.

In some embodiments, pre-NFT player position certificates (PNPPC) 118 corresponding to selected NFT wager tickets 112 are also created and offered for sale on storefront 116.

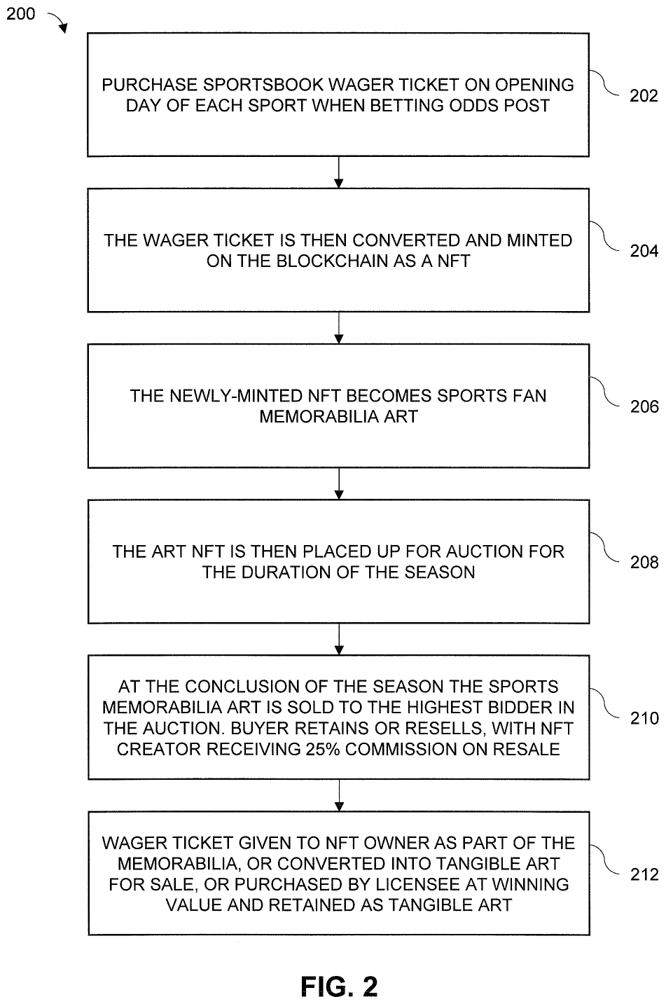

Referring now to FIG. 2, a process for converting wager tickets to NFT memorabilia is shown and generally designated 200. Process 200 is performed in conjunction with system 100 (shown in FIG. 1) or similar supporting structure.

Process 200 begins with step 202, in which a wager ticket for a sport is purchased from a sportsbook on opening day when betting odds post. In step 204, the wager ticket is converted and minted as a non-fungible token (NFT) on a distributed ledger. In preferred embodiments, the ledger used is a blockchain ledger such as Ethereum. The NFT becomes sports fan memorabilia art, as illustrated by step 206.

In step 208, the NFT is placed up for auction for the duration of the season. In preferred embodiments, this takes place via storefront 116 (see FIG. 1), and in some embodiments the auction takes place for a more limited duration of time, such as thirty (30) days, ninety (90) days, or three (3) months.

At the conclusion of the season, or the end of the auction, step 210 is performed, in which the NFT is sold to the highest bidder. The winning bidder can then retain the NFT as memorabilia art, or resell it, with the operator of system 100 (shown in FIG. 1) receiving a commission on the resale. In a preferred embodiment, this commission is twenty-five (25) percent of the resale price.

In step 212, the winning bidder who purchased the NFT receives the original physical wager ticket as memorabilia. Alternatively, the winning bidder may receive the winning value of the wager ticket instead of the physical wager ticket itself.

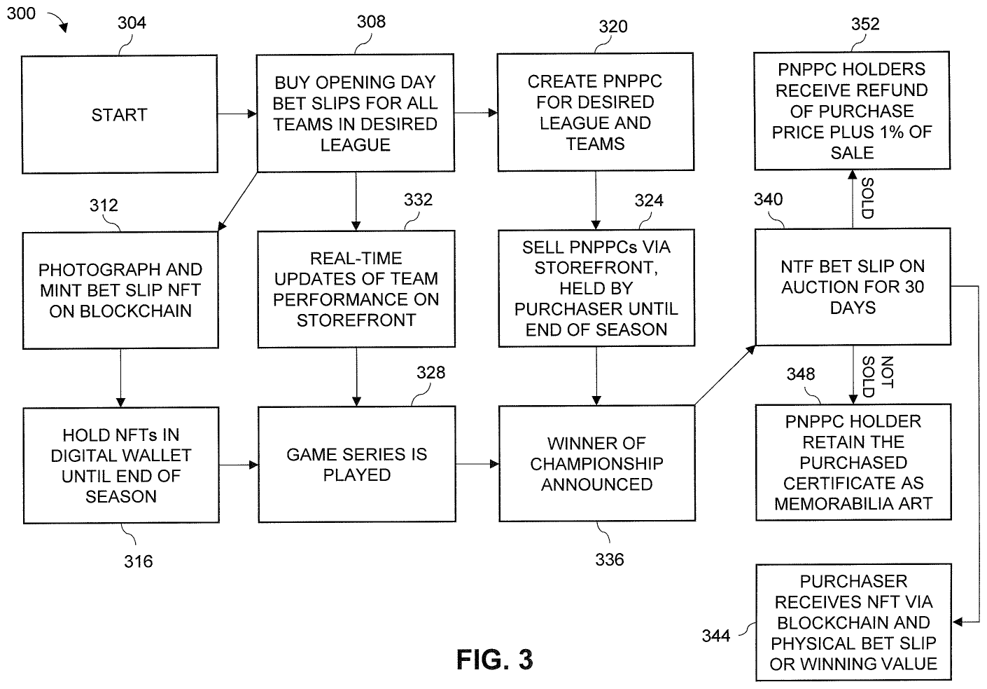

Referring now to FIG. 3, a detailed diagram of process flow for a preferred embodiment of a process for converting wager tickets to NFT memorabilia is illustrated and generally designated 300. Box 304 indicates the start of process 300. As illustrated by box 308, wager tickets (bet slips) are purchased for all teams in a league on opening day. Each ticket is then photographed and minted as a NFT on a blockchain or other distributed ledger, as illustrated by box 312. The NFTs are held in a digital wallet until the end of the season, as indicated by box 316.

As shown in box 320, not only NFTs are created for wager tickets for each team, but for selected teams pre-NFT player position certificates (PNPPC) are also created. The PNPPCs are sold on storefront 116 (shown in FIG. 1) or the equivalent and held by their buyers until the end of the season, as shown by box 324. As the game series is played, shown by box 328, real-time updates on team performance are provided at storefront 116 (shown in FIG. 1) as indicated by box 332.

At the end of the season, the winning team is announced, as shown by box 336. As illustrated by box 340, the NFT bet slips are placed on sale at auction for thirty (30) days. As indicated by box 344, the purchaser of the NFT at auction will receive the NFT via the blockchain and will also receive wither the physical bet slip or the value of its winnings.

If the NFT corresponds to a PNPPC and was not sold, the PNPPC holder retains the purchased certificate as sports memorabilia art, as shown by box 348. As shown by box 352, if the NFT is sold, the PNPPC holders receive a refund of the purchase price plus one (1) percent of the total selling value of the NFT. However, if the NFT is not sold within thirty (30) days, the PNPPC holder has the option to receive a two hundred (200) percent refund of the original purchase price, but in doing so forfeits the one (1) percent of the selling value of the NFT if the NFT is sold as the auction continues for up to three (3) months.

Additional embodiments based on the above-discussed preferred embodiments are fully contemplated, including the addition of steps from process 200 (shown in FIG. 2) to process 300 (shown in FIG. 3) or vice-versa; the replacement of steps in process 200 with steps from process 300 or vice-versa; and other combinations of the above-described embodiments.

While there have been shown what are presently considered to be preferred embodiments of the present invention, it will be apparent to those skilled in the art that various changes and modifications can be made herein without departing from the scope and spirit of the invention.

What is claimed is:

1. A process, comprising the steps of:
purchasing a wager ticket on opening day;
minting the wager ticket as a non-fungible token (NFT) on a distributed ledger;
placing the NFT up for auction; and
selling the NFT to a highest bidder at the end of the season,
wherein the highest bidder also receives the wager ticket or the value of winnings from the wager ticket.

2. The process of claim 1, wherein the NFT is placed up for auction for the duration of the season.

3. The process of claim 1, wherein the NFT is placed up for auction for a thirty-day period at the end of the season.

4. The process of claim 1, wherein the distributed ledger is a blockchain.

5. The process of claim 4, wherein the distributed ledger is the Ethereum blockchain.

6. The process of claim 1, wherein the auction takes place at an internet storefront.

7. A process, comprising the steps of:
buying opening day bet slips for all teams in a league;
photographing and minting the bet slips as non-fungible tokens (NFTs) on a blockchain;
creating pre-NFT player position certificates (PNPPCs) for selected teams;
selling the PNPPCs;
auctioning the NFTs;
providing each winning bidder with the NFT purchased; and
providing PNPPC holders with a refund of the PNPPC purchase price and a commission from the sale of a corresponding NFT.

8. The process of claim 7, wherein the PNPPCs are sold at an internet storefront.

9. The process of claim 7, wherein the NFTs are minted on the Ethereum blockchain.

10. The process of claim 7, further comprising the step of holding the NFTs in a digital wallet until the end of the season, wherein the step of auctioning the NFTs occurs at the end of the season.
